(19) United States
(12) Patent Application Publication
(10) Pub. No.: US 2014/0004422 A1
(43) Pub. Date: Jan. 2, 2014

(54) POSITIVE ELECTRODE ACTIVE MATERIAL FOR MAGNESIUM SECONDARY BATTERY, MAGNESIUM SECONDARY BATTERY, METHOD FOR MANUFACTURING POSITIVE ELECTRODE ACTIVE MATERIAL FOR MAGNESIUM SECONDARY BATTERY, AND METHOD FOR MANUFACTURING MAGNESIUM SECONDARY BATTERY

(71) Applicants: Jun Yang, Shanghai (CN); Yanna Nuli, Shanghai (CN)

(72) Inventors: Jun Yang, Shanghai (CN); Yanna Nuli, Shanghai (CN)

(73) Assignee: SHOEI CHEMICAL INC., Tokyo (JP)

(21) Appl. No.: 14/005,008

(22) PCT Filed: Mar. 27, 2012
(86) PCT No.: PCT/JP2012/057915

§ 371 Date: Sep. 13, 2013

(30) Foreign Application Priority Data
Mar. 30, 2011 (CN) 201110078533.8

(51) Int. Cl. H01M 4/58; C01B 33/32

(52) U.S. Cl. CPC H01M 4/5825; C01B 33/32
USPC 429/221; 429/231.6; 429/223; 423/332

(57) ABSTRACT

The purpose of the present invention is to provide a magnesium secondary battery, which can be charged with electricity and can discharge electricity to be used as a magnesium secondary battery and is capable of improving characteristics of magnesium secondary batteries The positive electrode active material for a magnesium secondary battery is expressed by compositional formula of MgMSiO₄, where M contains at least one element selected from among Co, Ni and Fe.

### TECHNICAL FIELD

The present invention relates to a positive electrode (cathode) active material for magnesium secondary battery, a magnesium secondary battery, a method for manufacturing a positive electrode (cathode) active material for magnesium secondary battery, and a method for manufacturing a magnesium secondary battery.

### BACKGROUND ART

As a variety of environmental problems including global warming and urban warming have emerged in recent years, there has been a sharp increasing demand for secondary batteries, in particular lithium ion secondary battery as a substitute for fossil fuels. The lithium ion secondary battery is characterized by its light weight and large capacity as compared with conventional lead secondary battery and nickel-cadmium secondary battery, and has therefore widely been used as a power source for mobile phone, notebook personal computer and so forth. It has recently been used also as batteries for electric vehicle, plug-in hybrid car, pedelec and so forth.

Lithium, which is a material for the lithium ion secondary battery, is however concerned about localized producing region and sharp rise in price as the demand therefor increases. The battery is also limitative in terms of capacity and energy density in principle due to monovalency of lithium ion. In applications of electric vehicle and so forth, there are further demands for larger capacity and higher energy density of the secondary battery. There is, therefore, a strong expectation for development of secondary battery using divalent metal ion from which larger capacity and higher energy density, as compared with those of lithium ion secondary battery, are expectable in principle.

Magnesium is an abundant resource and is far inexpensive than lithium. Metal magnesium has a relatively large ionization tendency, and can yield a large quantity of electricity per unit volume as a result of redox reaction. Also a high level of safety is expectable when it is used for batteries. The magnesium secondary battery is therefore said to be a battery capable of making up for the shortcomings of the lithium ion secondary battery. As described above, metal magnesium and magnesium ion are very promising materials respectively as an electrode active material and as a charge carrier in electrolyte solution of electro-chemical devices.

Among materials composing the magnesium secondary battery, the positive electrode (cathode) material may possibly be composed of an oxide containing magnesium ion.

Non-Patent Literature 1 proposes a magnesium secondary battery using Mg_{1.03}Mn_{0.97}SiO₄ as the positive electrode active material. The battery does, however, not satisfy characteristics required for practical secondary battery, only to stay behind the lithium ion secondary battery.

On the other hand, Non-Patent Literature 2 reports results of investigations into magnesium cobalt silicate having a laminar structure, although not as the positive electrode material for the secondary battery.

### CITATION LIST

### Non-Patent Literature

Non-Patent Literature 1: Z. Feng, J. Yang, Y. NuLi, J. Wang, J. Power Sources, 184, (2008) 604-609.

Non-Patent Literature 2: R. Rinaldi, G. D. Gatta, G. Artioli, K. S. Knight, C. A. Geiger, Phys. Chem. Minerals, 32, (2005) 655-664.

### SUMMARY OF THE INVENTION

### Problem to be Solved by the Invention

A multiple oxide containing magnesium ion is a possible candidate for the positive electrode material for magnesium secondary battery and a multiple oxide which allows insertion and extraction of magnesium ion is hopeful. Insertion and extraction of magnesium ion has, however, been confirmed in only a single case described in Non-Patent Literature 1. The multiple oxide is understood to be still insufficient as the positive electrode material of practical secondary batteries as described above.

Non-Patent Literature 2 exemplifies magnesium cobalt silicate as the multiple oxide containing magnesium ion, without suggesting possibility of insertion and extraction of magnesium ion, nor specific applications thereof at all. In short, Non-Patent Literature 2 discloses nothing about possibility of the multiple oxide as the battery material, nor battery performances.

As described above, while a number of multiple oxides containing magnesium ion have been known based on crystallography, there has been no study case of finding out the multiple oxide which allows insertion and extraction of magnesium ion and allows easy insertion and extraction of magnesium ion when used as the positive electrode material, from an almost infinite number of multiple oxides containing magnesium ion.

The present invention was conceived after considering the situations above, and objects of which is to provide a positive electrode active material for magnesium secondary battery capable of discharging and charging when used for a magnesium secondary battery, and also capable of improving performances of the magnesium secondary battery, a magnesium secondary battery, a method for manufacturing a positive electrode active material for magnesium secondary battery, and a method for manufacturing a magnesium secondary battery.

### Means to Solve the Problem

According to the invention of claim 1, there is provided a positive electrode active material for magnesium secondary battery. The positive electrode active material is represented by a compositional formula of MgMSiO₄, and M includes at least one element selected from the group consisted of Co, Ni and Fe.

According to the invention of claim 2, there is provided the positive electrode active material for magnesium secondary battery of claim 1, wherein the positive electrode active material has a hierarchical porous structure.

According to the invention of claim 3, there is provided a magnesium secondary battery which includes the positive electrode active material for magnesium secondary battery described in claim 1 or 2.

According to the invention of claim 4, there is provided a method for manufacturing a positive electrode active material for magnesium secondary battery. A multiple oxide represented by a compositional formula of MgMSiO₄ is used as a positive electrode active material, and M includes at least one element selected from the group consisted of Co, Ni and Fe.

According to the invention of claim 5, there is provided a method of manufacturing a magnesium secondary battery. A positive electrode active material of the magnesium secondary battery uses a multiple oxide represented by a compositional formula of MgMSiO₄, and M includes at least one element selected from the group consisted of Co, Ni and Fe.

### Advantageous Effects of the Invention

According to the present invention, a positive electrode active material for magnesium secondary battery, which is capable of discharging and charging when used for a magnesium secondary battery, and also capable of improving performances of the magnesium secondary battery, may be provided.

### BRIEF DESCRIPTION OF DRAWINGS

FIG. 1 shows XRD patterns of powder samples obtained in Example, while varying the final sintering temperature, in the process of manufacturing MgCoSiO₄, in the range from 600 to 1,000° C.

FIG. 2 is a SEM observation image of sample 1-2 in Example.

FIG. 3 is a TEM observation image of sample 1-2 in Example.

FIG. 4 is a drawing illustrating a discharge curve for explaining actual energy density.

### DESCRIPTION OF EMBODIMENTS

The positive electrode active material for magnesium secondary battery of the present invention will be explained below.

The positive electrode active material for magnesium secondary battery of the present invention, (simply referred to as “positive electrode active material”, hereinafter) is used as one of the positive electrode material of the positive electrode of the magnesium secondary battery. The positive electrode generally contains the positive electrode active material, a conductive additive, and a binder. The positive electrode is manufactured on a positive electrode collector (metal foil, in general) by coating thereon a paste, using a coater, prepared by dispersing these three components into slurry with a dispersion medium and then vaporizing off the dispersion medium.

The present inventors found out that the multiple oxide represented by the compositional formula of MgMSiO₄ and containing any one of Co, Ni and Fe for M allowed easy insertion and extraction of magnesium ion, and was proven to be very excellent as the positive electrode active material for magnesium secondary battery. The positive electrode active material of the present invention is therefore represented by the compositional formula of MgMSiO₄, where M contains at least one element selected from Co, Ni and Fe. Among Co, Ni and Fe, the positive electrode active material preferably contains Co and/or Ni, from the viewpoint of obtaining higher potential and larger energy density. On the other hand, the positive electrode active material preferably contains Fe, particularly from the viewpoint of price (low cost).

The M may simultaneously contain two or more elements selected from Co, Ni and Fe. The M may also be substituted partially by a metal element other than the three metal elements.

Note that the present invention allows slight compositional variation in the compositional formula above, typically ascribable to crystal defects.

The positive electrode active material of the present invention more preferably has a three-dimensional hierarchical porous structure (referred to as “hierarchical porous structure”, hereinafter). This sort of hierarchical porous structure makes charge transfer more efficient and makes the electrolyte more permeable. More specifically, in the hierarchical porous structure with a nanometers-thick pore wall, also diffusion length of ion is reduced to nanometers, so that the diffusion polarization may be suppressed and thereby charge/discharge can occur at a high rate. Also since the specific surface area will be relatively large, so that the area of an interface where the electrode and the electrolyte come into contact increases, and this facilitates a charge transfer reaction at the interface. The hierarchical porous structure which has an inverse opal structure in one of its layers is more preferable, since an ordered and precise channel (tunnel) may be formed. This sort of pore structure successfully minimizes winding or twisting of permeation path of electrolyte, and thereby prevents occurrence of regions where ions are depleted or condensed, Accordingly, there will be no fear of degradation of battery performances under a high reaction rate. Since the skeleton thereof has a continuous structure, so that the positive electrode active material will be excellent in electro-conductivity and allows smooth electrochemical insertion (insertion of ions) and extraction of Mg²⁺, ensuring large cycle capacity under higher discharge rate.

The positive electrode active material of the present invention is used for a magnesium secondary battery, and therefore makes it a secondary battery having an energy density larger than that of lithium ion secondary battery in a high-charged use. The positive electrode active material is also preferable in view of using magnesium which is more inexpensive and safer than lithium.

Next, a method for manufacturing the positive electrode active material for magnesium secondary battery of the present invention will be explained.

The method of manufacturing is exemplified by templating, atomized pyrolysis, and sol-gel process. In particular, the templating is preferable by virtue of readiness in forming the hierarchical porous structure. The paragraphs below will explain the templating and the atomized pyrolysis.

### [Templating]

### <<Preparation of Precursor Solution>>

Materials for precursor solution are exemplified by metal salts and oxides which are soluble or dispersible into water or organic solvents. For example, materials for Mg and M (Co, Ni, Fe) are exemplified by chloride, nitrate, organic acid salts (acetate, oxalate, etc.), acetylacetonate, alkoxide, and carbonate. Materials for Si are exemplified by silica powder, colloidal silica, and alkoxide (tetraethoxysilane, tetramethoxysilane, etc., and oligomers thereof).

These materials are dissolved into water or an organic solvent to prepare the precursor solution having a predetermined composition.

<<Formation of Template>>

Organic resin powder which is insoluble into the solvent and removable after being decomposed under heating may be used as a template. Such an organic resin is exemplified by acrylic resin, polystyrene resin, polypropylene resin, and phenol resin. Since the particles of the organic resin powder serve as the template, so that every single layer of the hierarchical porous structure is determined by the particle size. In order to form the inverse opal structure, the particles are preferably monodisperse spherical particles.

The above-described organic resin powder and spherical particles usable herein are commercially available, or may he synthesized. For example, polystyrene resin is commercially available in the form of spherical particles with a variety of sizes, and is arbitrarily selectable, or may be synthesized as described in the next.

The polystyrene resin may be synthesized by polymerizing styrene. The polymerization proceeds not only by radical polymerization but also by anionic polymerization or cationic polymerization. For example, styrene monomers may be radically polymerized using a potassium peroxodisulfate as a radical initiator to yield a polystyrene resin powder. In order to obtain monodisperse spherical polystyrene particles, polyvinylpyrrolidone is dissolved into water, further added with potassium peroxodisulfate and styrene and the solution is then heated to promote the polymerization.

<<Manufacture of Positive Electrode Active Material>>

The precursor solution described above is added with an organic resin powder which serves as the template and the mixture is thoroughly stirred. The mixed solution is placed in an autoclave and heated to 100 to 200° C. for 10 to 100 hours, without stirring. After the heating in the autoclave, the solid matter is dried, and then calcined to pyrolyze off the template, to thereby form the hierarchical porous structure.

Calcination temperature is arbitrarily adjustable to a temperature at which the organic resin, which serves as the template, may be pyrolyzed, depending on the types of the organic resin. The calcination temperature is generally 300° C. to 700° C., and preferably 350° C. to 700° C. from the viewpoint of facilitating formation of the hierarchical porous structure. The hierarchical porous structure is controllable by regulating the calcination temperature. Since the hierarchical porous structure may sometimes decay under calcination at high temperatures due to particle growth, so that the calcination temperature is preferably 700° C. or below. On the other hand, the calcination temperature is preferably 300° C. or above, since the precursor will not start to decompose in some cases below 300° C.

[Atomized Pyrolysis]

Materials used in the atomized pyrolysis are compounds containing elements which compose the metal oxides, and are soluble in water or organic solvents. Solution containing the compounds dissolved therein is converted into droplets by ultrasonic wave or through a nozzle (two-fluid nozzle, four-fluid nozzle, etc.), the droplets are then introduced into a heating furnace at 400 to 1,200° C. to be pyrolyzed, and thereby the metal oxide may be produced.

In a specific case of producing MgFeSiO₄, magnesium nitrate Mg(NO₃)₂?6H₂O, iron (III) nitrate Fe(NO₃)₃?9H₂O and colloidal silica, for example, are weighed according to the stoichiometry and dissolved into water. The solution having the compounds dissolved therein is converted into droplets using, for example, an ultrasonic atomizer, and then introduced into a heating furnace at 500 to 900° C. together with nitrogen gas used as a carrier gas so as to be pyrolyzed. In a specific case of producing MgNiSiO₄, magnesium nitrate Mg(NO₃)₂?6H₂O, nickel (II) nitrate hexahydrate Ni(NO₃)₂?6H₂O, and colloidal silica, for example, are weighed according to the stoichiometry and dissolved into water. The solution having the compounds dissolved therein is converted into droplets using an ultrasonic atomizer and then introduced into a heating furnace at 500 to 900° C. together with nitrogen gas used as a carrier gas so as to be pyrolyzed.

The thus-produced metal oxide may further be heat-treated and/or crushed.

The magnesium secondary battery of the present invention will be explained in the next.

The magnesium secondary battery, although not illustrated, has a positive electrode and a negative electrode (anode) isolated from each other by a separator. A cell chamber surrounded by a positive electrode collector of the positive electrode and a negative electrode collector of the negative electrode is filled with an electrolyte solution (electrolyte). The magnesium secondary battery is used while being connected through the positive electrode and the negative electrode thereof to an external circuit.

The positive electrode is manufactured by coating a paste which is prepared by dispersing the above-described positive electrode active material, a conductive additive and a cohesive agent into slurry with a dispersion medium onto the positive electrode collector using a coater, and by vaporizing off the dispersion medium.

The conductive additive is not specifically limited so long as it is substantially a chemically stable electro-conductive material. The conductive additive is exemplified by carbon materials including graphites such as natural graphite (flaky graphite, etc.) and artificial graphite; acetylene black; Ketchen black; carbon blacks such as channel black, furnace black, lamp black and thermal black; and carbon fiber; and also by electro-conductive fibers such as metal fiber; fluorinated carbon; metal powders such as those composed of aluminum; zinc oxide; electro-conductive whiskers such as those composed of potassium titanate; electro-conductive metal oxides such as titanium oxide; and organic electro-conductive materials such as polyphenylene derivative. Only a single species of them may be used independently, or two or more species of them may be used in combination. Among them, carbon materials such as acetylene black, Ketchen black and carbon black are particularly preferable. Amount of use of the conductive additive is generally at around 1 to 25% by mass relative to the total mass of the positive electrode.

The cohesive agent (also referred to as gluing agent or binder) serves to bond the active material and the conductive additive. The cohesive agent is preferably a substance chemically and electro-chemically stable against the electrolyte and the solvent thereof of the secondary battery. Both thermoplastic resin and thermosetting resin are acceptable as the cohesive agent. The examples include polyolefins such as polyethylene and polypropylene; fluorine-containing resins such as polytetrafluoroethylene (PTFE), polyvinylidene fluoride(PVDF), tetrafluoroethylene-hexafluoroethylene copolymer, tetrafluoroethylene-hexafluoropropylene copolymer (FEP), tetrafluoroethylene-perfluoroalkyl vinyl ether copolymer (PFA), vinylidene fluoride-hexafluoropropylene copolymer, vinylidene fluoride-chlorotrifluoroethylene copolymer, ethylene-tetrafluoroethylene copolymer (ETFE resin), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, and vinylidene fluoride-perfluoromethyl vinyl ether-tetrafluoroethylene copolymer; styrene butadiene rubber (SBR); ethylene-acrylic acid copolymer or Na⁺ ion-crosslinked product of the copolymer; ethylene-methacrylic acid copolymer or Na⁺ ion-crosslinked product of the copolymer; ethylene-methyl acrylate copolymer or Na⁺ ion-crosslinked product of the copolymer; ethylene-methyl methacrylate copolymer or Na⁺ ion-crosslinked product of the copolymer; and carboxymethyl cellulose. These materials may be used in combination. Among these materials, PDF and PTFE are particularly preferable. Amount of use of the cohesive agent is generally at around 1 to 20% by mass relative to the total mass of the positive electrode.

The dispersion medium usable herein is water or organic solvent. Those capable of forming a paste and may be vaporized off after coated on the collector are preferable as the dispersion medium.

For the positive electrode collector, generally used is an electro-conductive metal foil which is exemplified by those made of copper, stainless steel (SUS), aluminum and aluminum alloy. The thickness may be 5 μm to 50 μm.

The active material of the negative electrode is exemplified by metal magnesium. The metal magnesium may be pure metal magnesium or magnesium alloy. Pure metal magnesium is preferable from the viewpoint of increasing energy capacity of the electrode active material. On the other hand, magnesium alloy is preferable from the viewpoint of increasing battery performances other than energy capacity, such as stabilizing the negative electrode against repetitive charge/discharge.

The negative electrode active material is disposed so as to be brought into contact with the negative electrode collector. As the negative electrode collector, usable material is a metal foil, which is exemplified by those made of pure or alloyed copper, nickel and titanium, or stainless steel foil.

The separator is exemplified by those made of polyethylene glycol and so forth. The separator is disposed between the positive electrode and the negative electrode so as to avoid direct contact between the both.

The separator will suffice if it is an insulating film having large ion permeability and a certain level of mechanical strength. Materials composing the separator include olefin polymer, fluorine-containing polymer, cellulosic polymer, polyimide, nylon, glass fiber, and alumina fiber, which are in the form of non-woven fabric, woven fabric, or microporous film. Particularly preferable materials include polypropylene, polyethylene, mixture of polypropylene and polyethylene, mixture of polypropylene and polytetrafluoroethylene (PTFE), and mixture of polyethylene and polytetrafluoroethylene (PTFE), preferably in the form of microporous film. In particular, the microporous film having a pore size of 0.01 to 1 μm and a thickness of 5 to 50 μm is preferable. The microporous film may be a single film or may be a composite film composed of two or more layers differed in properties such as pore geometry, density and quality. An example may be a composite film having a polyethylene film and a polypropylene film bonded with each other.

The electrolyte solution is generally composed of an electrolyte (supporting salt) and a non-aqueous solvent. The supporting salt used in the magnesium secondary battery is mainly magnesium salt.

In the process of charging of the magnesium secondary battery of the present invention, a reaction represented by the formula below proceeds at the positive electrode:

MgMSiO₄→Mg₁₋ₓMSiO₄+xMg²⁺+2e⁻

where as magnesium ions are extracted from the positive electrode active material, M ion increases the valence thereof, and thereby releases electrons out through the collector into an external circuit. On the other hand, magnesium ion dissolves into the electrolyte solution, diffuses in the electrolyte solution and migrates towards the negative electrode. In this process, a reaction represented by the formula below proceeds at the negative electrode:

Mg²⁺2e⁻→Mg

where the magnesium ion, which is a negative electrode active material, is reduced by electrons coming through the external circuit and accumulated in the collector, and deposits in the form of metal magnesium.

In the process of discharge, reverse reactions proceed at the individual electrodes. At the negative electrode, a reaction represented by the formula below proceeds:

Mg→Mg²⁺+2e⁻

where metal magnesium or alloy thereof, which is a negative electrode active material, is oxidized and releases electrons through the negative electrode collector out into the external circuit. Magnesium ion produced by the reaction dissolves into the electrolyte solution, diffuses in the electrolyte solution and migrates towards the positive electrode.

Magnesium ion migrated to reach the positive electrode diffuses through the hierarchical porous structure of the positive electrode active material and then absorbed (inserted) into the positive electrode active material. In this process, a reaction represented by the formula below proceeds at the positive electrode:

Mg₁₋ₓMSiO₄+xMg²⁺+2e⁻→MgMSiO₄

where Mg²⁺ ion is absorbed and M ion decreases the valence thereof to incorporate electrons through the positive electrode collector from the external circuit.

### EXAMPLE

The present invention will specifically be explained below referring to Examples, without limiting the present invention.

### (1) Example 1

### [Manufacture of Positive Electrode Material by Templating]

### <<Preparation of Precursor Solution>>

The individual materials listed Table 1 were dissolved into pure water to prepare mixed solutions of a concentration of 1 mol/L such that the resultant compositions become those as described in Table 1. SiO₂ material listed in Table 1 was silica of 15 to 20 nm diameter.

<<Formation of Template>>

Into 300 mL of ion exchanged water, 4.2 g of polyvinylpyrrolidone (Mw=30,000) was dissolved under stirring, and potassium persulfate (0.14 g) and 31.5 mL of styrene were added. The obtained mixed solution was deoxygenized by bubbling with argon gas at room temperature for one hour, then heated to 70° C. and allowed to polymerize under an argon atmosphere over 24 hours. The product was centrifuged for 30 minutes, the synthesized monodisperse polystyrene (PS) spherical powder was aligned to form a colloidal crystal, and dried at 50° C. for 24 hours. The PS sphere was further heat-treated at 100° C. for 10 minutes to enhance the strength, to thereby obtain a dry template.

The thus obtained template showed an opal-like reflection ascribable to optical diffraction, and was confirmed to have a hexagonal close-packed arrangement.

<<Manufacture of Positive Electrode Active Material>>

One gram of the template was added and mixed with 10 mL of the precursor solution, the mixture was stirred for 6 hours so as to promote infiltration of the material into a gap of the PS spherical powder, and then heated in an autoclave at 120° C. for 24 hours. The obtained deposit was colleted by filtration, dried at 100° C., placed in a tubular furnace so as to decompose the organic component, heated at a heating rate of 2° C./min and sintered at 500° C. for 3 hours. The product was further sintered in the atmospheres listed in Table 1 at 700° C. for 6 hours in order to completely remove the organic residue, and then cooled down to room temperature. Samples 1-1 to 1-7 listed in Table 1 were obtained in this way.

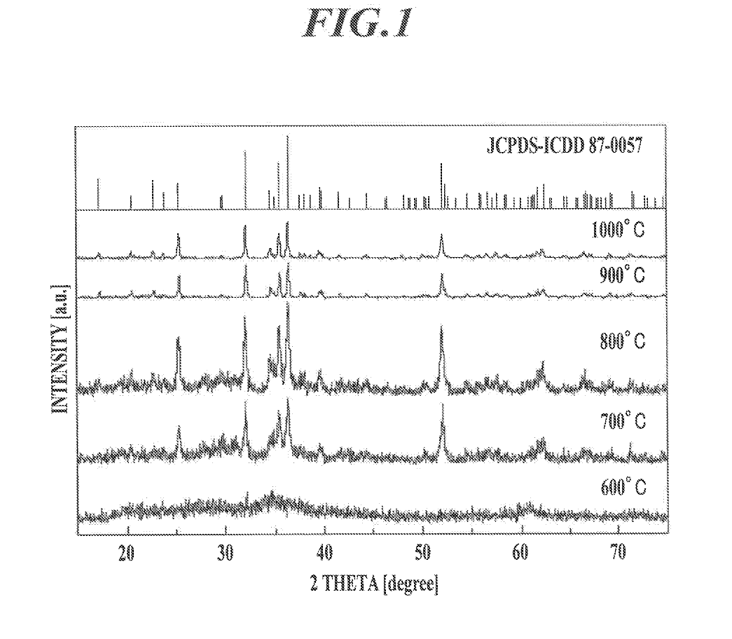

FIG. 1 shows XRD patterns of the powder samples obtained when the final sintering temperature was varied over 600 to 1000° C., in the process of manufacturing MgCoSiO₄ similarly to sample 1-2 (the sample at 700° C. corresponds to sample 1-2). It is understood from FIG. 1 that single-phase crystalline MgCoSiO₄ is obtained at a sintering temperature of 700° C. or above and that diffraction peaks become sharper as the sintering temperature elevates, indicating higher degree of crystallinity.

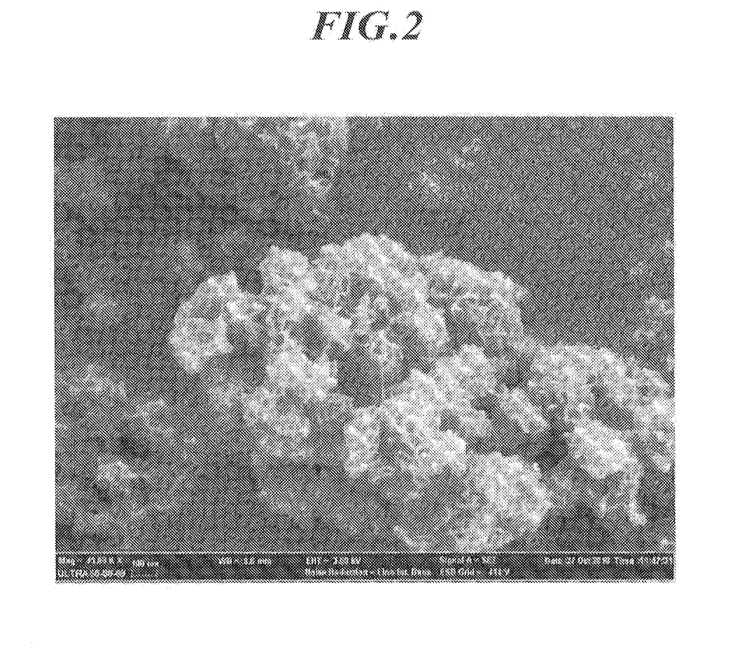

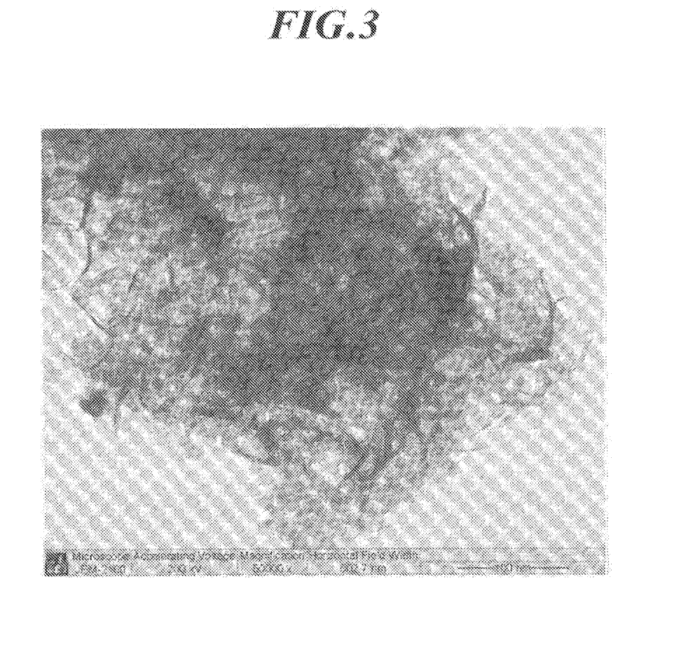

FIG. 2 and FIG. 3 are images of sample 1-2 observed by a SEM and a TEM, respectively. It is known from FIG. 2 and FIG. 3 that a three-dimensional structure is formed by a joined wall surrounding the continuous pores. The surface of the structure has a poor regularity, with a partial clogging of the pores. This is supposedly ascribable to an excessive precursor entering the pores.

Each of the thus obtained samples 1-1 to 1-7 was added with 20% by mass of acetylene black, mixed in a ball mill for 4 hours, and then heat-treated in an argon gas flow at 500° C. for 2 hours, to thereby coat carbon onto the surfaces of the samples 1-1 to 1-7.

### [Evaluation]

Actual energy density of the secondary batteries using the carbon-coated samples as the positive electrode active material was evaluated according to the procedures below.

Sample batteries were manufactured by using samples 1-1 to 1-7 respectively for the positive electrodes, metal magnesium for the negative electrodes and a non-aqueous electrolyte solution.

The positive electrode was manufactured as follows. Powder of each samples 1-1 to 1-7 combined with carbon, Super-P carbon powder, and polyvinylidene fluoride were mixed at a ratio by mass of 70:20:10, and made into a slurry using N-methyl-2-pyrrolidinone as a dispersion medium. The slurry was coated on the collector composed of a copper foil, and dried in vacuo at 100° C. for 4 hours, to thereby manufacture the positive electrode. A metal magnesium plate was used as the negative electrode. A 0.25 mol/L solution of Mg(AlCl₂EtBu)₂/THF was used as the electrolyte solution. The electrolyte solution was prepared by mixing a MgEu₂ solution (1 mol/L in hexane) and an AlCl₂Et solution (0.9 mol/L in heptane) at a ratio of 1:2 at room temperature, then white solid precipitate was immediately formed therein. After stirring for 48 hours, hexane and heptane were completely dried off and the residue was added with high-purity tetrahydrofuran, to thereby prepare the 0.25 mol/L solution. The entire procedures were conducted in a glove box under an argon atmosphere.

Polyethylene (PE) filter paper was used as the separator. Using the positive electrodes, the negative electrode, the electrolyte solution and the separator described above, CR2016 coin batteries were assembled in the glove box under an argon atmosphere.

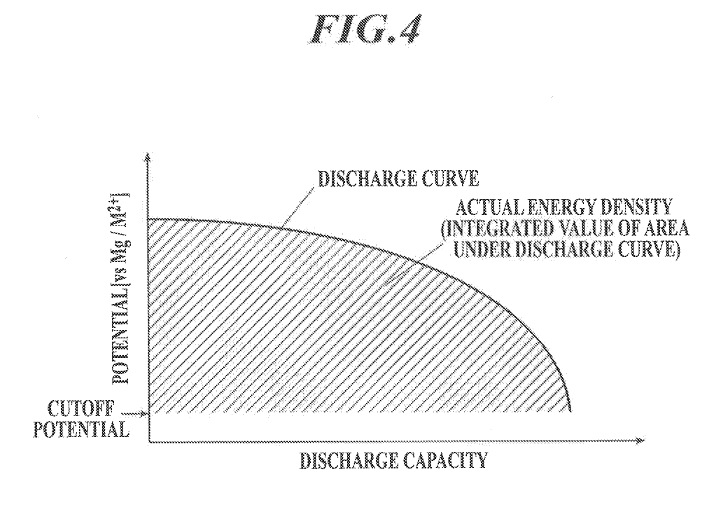

Five batteries were manufactured for each sample, subjected to a charge/discharge test in a thermostat chamber at 25° C., and the actual energy density was determined based on integrated values of area under discharge curves obtained at a rate of 0.25 C. FIG. 4 is a drawing illustrating a discharge curve for explaining actual energy density.

An average value of three batteries out of five batteries, excluding those showing the maximum value and the minimum value, was determined, and judged as “o” if it was larger (i.e., the actual energy density improved) than the actual energy density value of sample 1-1 representing the conventional battery, and judged as “x” if it was smaller (i.e., the actual energy density not improved). Results are summarized in Table 1 below.

TABLE 1

| | | | | | | ACTUAL | |
|---|---|---|---|---|---|---|---|
| | COMPOSITIONAL | | MANUFACTURING | CALCINATION | CALCINATION | ENERGY | |
| No. | FORMULA | MATERIALS | METHOD | TEMPERATURE | ATMOSPHERE | DENSITY * 1 | REMARK |
| 1-1 | Mg_{1.03}Mn_{0.97}SiO₄ | Mg(CH₃COO)₂·4H₂O, | TEMPLATING | 700° C. | 4% H₂/Ar | — | REFERENCE |
| | | Mn(CH₃COO)₂·4H₂O, | | | | | SAMPLE |
| | | SiO₂ | | | | | |
| 1-2 | MgCoSiO₄ | Mg(CH₃COO)₂·4H₂O, | TEMPLATING | 700° C. | Ar | ○ | EXAMPLE |
| | | Co(CH₃COO)₂·4H₂O, | | | | | |
| | | SiO₂ | | | | | |
| 1-3 | MgFeSiO₄ | Mg(CH₃COO)₂·4H₂O, | TEMPLATING | 700° C. | 4% H₂/Ar | ○ | EXAMPLE |
| | | Fe(CH₃COO)₃, | | | | | |
| | | SiO₂ | | | | | |
| 1-4 | MgNiSiO₄ | Mg(CH₃COO)₂·4H₂O, | TEMPLATING | 700° C. | Ar | ○ | EXAMPLE |
| | | Ni(CH₃COO)₂·2H₂O, | | | | | |
| | | SiO₂ | | | | | |
| 1-5 | MgMnSiO₄ | Mg(CH₃COO)₂·4H₂O, | TEMPLATING | 700° C. | Ar | x | COMPARATIVE |
| | | Mn(CH₃COO)₂·4H₂O, | | | | | EXAMPLE |
| | | SiO₂ | | | | | |
| 1-6 | Mg(Ni_{0.9}Mn_{0.1})SiO₄ | Mg(CH₃COO)₂·4H₂O, | TEMPLATING | 700° C. | Ar | ○ | EXAMPLE |
| | | Ni(CH₃COO)₂·2H₂O, | | | | | |
| | | Mn(CH₃COO)₂·4H₂O, | | | | | |
| | | SiO₂ | | | | | |
| 1-7 | MgCuSiO₄ | Mg(CH₃COO)₂·4H₂O, | TEMPLATING | 700° C. | Ar | x | COMPARATIVE |
| | | Ni(CH₃COO)₂·2H₂O, | | | | | EXAMPLE |
| | | SiO₂ | | | | | |

### (2) Example 2

### [Manufacture of Positive Electrode Active Material by Atomized Pyrolysis]

The individual materials listed in Table 2 were dissolved into pure water to prepare 0.6 mol/L material solutions such that the resultant compositions become those as described in Table 2.

The thus prepared mixed solutions were converted into fine droplets using an ultrasonic atomizer, blown into an electric furnace heated at 600° C. for pyrolysis using the air as a carrier gas, and the products were collected.

The obtained products were then wet-crushed in a planetary ball mill using methanol as a dispersion medium and heat-treated for 4 hours in the atmospheres and at temperatures listed in Table 2, to thereby obtain samples 2-1 to 2-7 listed in Table 2. The individual samples thus obtained were coated with carbon similarly as described in Example 1.

[Evaluation]

Sample batteries were manufactured similarly as described in Example 1, by using samples 2-1 to 2-7 respectively for the positive electrodes, metal magnesium for the negative electrodes, and a non-aqueous electrolyte solution. Five batteries were manufactured for each sample, subjected to a charge/discharge test in a thermostat chamber at 25° C., and the performances were evaluated similarly as described in Example 1 except that the actual energy density was determined based on integrated values of area under discharge curves obtained at a rate of 0.5 C. Results of evaluation are summarized in Table 2 below.

TABLE 2

| | | | | HEAT- | HEAT- | ACTUAL | |
|---|---|---|---|---|---|---|---|
| | COMPOSITIONAL | | MANUFACTURING | TREATMENT | TREATMENT | ENERGY | |
| No. | FORMULA | MATERIALS | METHOD | TEMPERATURE | ATMOSPHERE | DENSITY * 2 | REMARK |
| 2-1 | Mg_{1.03}Mn_{0.97}SiO₄ | Mg(NO₃)₂·6H₂O, | ATOMIZED | 700° C. | 1% H₂/Ar | — | REFERENCE |
| | | Mn(NO₃)₂·6H₂O, | PYROLYSIS | | | | SAMPLE |
| | | COLLOIDAL SILICA | | | | | |
| 2-2 | MgCoSiO₄ | Mg(NO₃)₂·6H₂O, | ATOMIZED | 700° C. | Ar | ○ | EXAMPLE |
| | | Co(NO₃)₂·6H₂O, | PYROLYSIS | | | | |
| | | COLLOIDAL SILICA | | | | | |
| 2-3 | MgFeSiO₄ | Mg(NO₃)₂·6H₂O, | ATOMIZED | 700° C. | 1% H₂/Ar | ○ | EXAMPLE |
| | | Fe(NO₃)₂·9H₂O, | PYROLYSIS | | | | |
| | | COLLOIDAL SILICA | | | | | |
| 2-4 | MgNiSiO₄ | Mg(NO₃)₂·6H₂O, | ATOMIZED | 700° C. | Ar | ○ | EXAMPLE |
| | | Ni(NO₃)₂·6H₂O, | PYROLYSIS | | | | |
| | | COLLOIDAL SILICA | | | | | |
| 2-5 | MgMnSiO₄ | Mg(NO₃)₂·6H₂O, | ATOMIZED | 700° C. | Ar | x | COMPARATIVE |
| | | Mn(NO₃)₂·6H₂O, | PYROLYSIS | | | | EXAMPLE |
| | | COLLOIDAL SILICA | | | | | |
| 2-6 | Mg(Ni_{0.9}Mn_{0.1})SiO₄ | Mg(NO₃)₂·6H₂O, | ATOMIZED | 700° C. | Ar | ○ | EXAMPLE |
| | | Ni(NO₃)₂·6H₂O, | PYROLYSIS | | | | |
| | | Mn(NO₃)₂·6H₂O, | | | | | |
| | | COLLOIDAL SILICA | | | | | |
| 2-7 | MgCuSiO₄ | Mg(NO₃)₂·6H₂O, | ATOMIZED | 700° C. | Ar | x | COMPARATIVE |
| | | Cu(NO₃)₂·3H₂O, | PYROLYSIS | | | | EXAMPLE |
| | | COLLOIDAL SILICA | | | | | |

It was understood from the results above that samples 1-2 to 1-4, 1-6, 2-2 to 2-4 and 2-6 containing Co, Ni and Fe for M in MgMSiO₄ were improved in the actual energy density as compared with reference samples 1-1 and 2-1.

### INDUSTRIAL APPLICABILITY

The present invention is applicable to the field of magnesium secondary battery.

What is claimed is:

1. A positive electrode active material for magnesium secondary battery, wherein;
the positive electrode active material being represented by a compositional formula of MgMSiO₄,
where M comprises at least one element selected from the group consisted of Co, Ni and Fe.

2. The positive electrode active material for magnesium secondary battery of claim 1, wherein the positive electrode active material has a hierarchical porous structure.

3. A magnesium secondary battery, comprising the positive electrode active material for magnesium secondary battery of claim 1.

4. A method for manufacturing a positive electrode active material for magnesium secondary battery, wherein;
a multiple oxide represented by a compositional formula of MgMSiO₄ is used as a positive electrode active material,
where M comprises at least one element selected from the group consisted of Co, Ni and Fe.

5. A method for manufacturing a magnesium secondary battery, wherein;
a positive electrode active material of the magnesium secondary battery uses a multiple oxide represented by a compositional formula of MgMSiO₄,
where M comprises at least one element selected from the group consisted of Co, Ni and Fe.

6. A magnesium secondary battery, comprising the positive electrode active material for magnesium secondary battery of claim 2.
